(19) United States
(12) Patent Application Publication
(10) Pub. No.: US 2026/0255301 A1
(43) Pub. Date: Aug. 27, 2026

(54) METHODS AND APPARATUSES FOR ENABLING SIDELINK POSITIONING FOR LOCATION OF OUT-OFCOVERAGE WIRELESS TRANSMIT/RECEIVE UNITS

(71) Applicant: InterDigital Patent Holdings, Inc., Wilmington, DE (US)

(72) Inventors: Jung Je Son, Warrington, PA (US); Samir Ferdi, Kirkland (CA); Michelle Perras, Montreal (CA); Saad Ahmad, Montreal (CA); Taimoor Abbas, Sainte-Julie (CA)

(73) Assignee: InterDigital Patent Holdings, Inc., Wilmington, DE (US)

(21) Appl. No.: 18/875,020

(22) PCT Filed: Jul. 28, 2023
(86) PCT No.: PCT/US23/71176

§ 371 Date: Dec. 13, 2024

Related U.S. Application Data
(60) Provisional application No. 63/393,307, filed on Jul. 29, 2022.

(51) Int. Cl. H04W 64/00; H04W 12/104; H04W 92/18

(52) U.S. Cl. CPC H04W 64/00; H04W 12/104; H04W 92/18

(57) ABSTRACT

A wireless transmit/receive unit (WTRU) may be configured to receive a sidelink (SL) positioning request from another WTRU. The first SL positioning request may include security information. The security information may be for validating the SL positioning request. The WTRU may be configured to send an SL positioning response to the other WTRU. The SL positioning response may be sent based on validation of the SL positioning request using at least the security information. The security information may be received in a security container. The WTRU may be configured to perform an SL positioning with the other WTRU.

### CROSS-REFERENCE TO RELATED APPLICATIONS

This application claims the benefit of U.S. Provisional Patent Application No. 63/393,307 filed on Jul. 29, 2022, the entire contents of which are incorporated herein by reference.

### BACKGROUND

Current mobile internet applications utilize user location information for various services such as navigation, customized content provisioning, and traffic optimization for ultra-high quality video streaming, etc. It is expected that more applications will utilize user location information and may be applicable for applications such as Drones, unmanned aerial vehicles (UAVs), vehicle-to-everything (V2X), and extended reality (XR).

In current fifth generation (5G) systems, the location information of a wireless transmit/receive unit (WTRU), also referred to a user equipment (UE), may be supported by various network technologies. These methods, however, do not address a WTRU that is not within network coverage (referred to as out-of-coverage).

### SUMMARY

Wireless communications between one or more user equipment (UE) and a network are considered herein. A UE also may be referred to as a wireless transmit/receive unit (WTRU). The terms UE and WTRU are used interchangeably herein. Methods and apparatuses are described herein for determining a location of a WTRU that is out of network (e.g., also referred to as out-of-coverage, herein). In an example embodiment, sidelink (SL) positioning is utilized between a WTRU that is in network and another WRTU that is not in the network. SL positioning may be accomplished via a PC5 interface between the WRTUs. In various example embodiments, a security container may be utilized for security and authentication purposes. A request for the location of an out-of-coverage WRTU may be initiated by another WRTU, a network entity (e.g., an AMF, a LMF, etc.), and/or an application (e.g., AF, LCS), or the like.

A first WTRU (e.g., a target WTRU) may be configured to receive an SL positioning request from a second WTRU (e.g., a located WTRU). The first SL positioning request may include security information. The security information may be for validating the SL positioning request. The first WTRU (e.g., target WTRU) may be configured to send an SL positioning response to the second WTRU (e.g., located WTRU). The SL positioning response may be sent based on validation of the SL positioning request, for example using at least the security information. The first WTRU (e.g., target WTRU) may be configured to perform an SL positioning with the second WTRU (e.g., located WTRU). Performing an SL positioning with the second WTRU (e.g., located WTRU) may include receiving an indication of one or more distance measurements or direction measurements associated with the second WTRU (e.g., located WTRU). Additionally, or alternatively, performing an SL positioning with the second WTRU (e.g., located WTRU) may include determining an indication of one or more distance measurements or direction measurements associated with the second WTRU (e.g., located WTRU).

The first WTRU (e.g., target WTRU) may be configured to receive configuration information. The configuration information may include one or more parameters, for example to derive security credentials for validating the security information in the SL positioning request. The security information may be received in a security container. The security container may be protected by security credentials, for example derived from the one or more parameters received in the configuration information.

The first WTRU (e.g., target WTRU) may be configured to verify the validity of the SL positioning request, for example by validating the security information received in the security container. The first WTRU (e.g., target WTRU) may be configured to perform discovery with the second WTRU (e.g., located WTRU), for example based on receipt of a (e.g., second) SL positioning request from a network. The security information may include one or more of an application function (AF) ID, location services (LCS) client information, a location information request for the first WTRU (e.g., target WTRU), a service type, a list of second WTRUs, quality of service (QOS) information, and/or a type of location request. The SL positioning request may include a list of second WTRUs (e.g., located WTRUs), for example in a security container. Validation of the SL positioning request may be based on one or more of the security information and/or the second WTRU (e.g., located WTRU) being in the list of second WTRUs (e.g., located WTRUs). The first WTRU (e.g., target WTRU) may be configured to initiate a mobile originated location request (MO-LR). The MO-LR may be based on the second WTRU (e.g., located WTRU) being in the list of second WTRUs (e.g., located WTRUS).

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures and the detailed description are not to be considered limiting, and other equally effective examples are possible and likely. Like reference numerals (“ref.” or “refs.”) in the Figures indicate like elements.

FIG. 1A is an example system diagram illustrating an example communications system in which one or more disclosed embodiments may be implemented.

FIG. 1B is an example system diagram illustrating an example wireless transmit/receive unit (WTRU) that may be used within the communications system illustrated in FIG. 1A according to an embodiment.

FIG. 1C is an example system diagram illustrating an example radio access network (RAN) and an example core network (CN) that may be used within the communications system illustrated in FIG. 1A according to an embodiment.

FIG. 1D is an example system diagram illustrating a further example RAN and a further example CN that may be used within the communications system illustrated in FIG. 1A according to an embodiment.

FIG. 2 depicts an example architecture for a 5G or NextGen network.

FIG. 3 depicts an example 5G/NextGen network comprising a location service.

FIG. 4 depicts an example process of a mobile terminated location request (MT-LR) for a target out-of-coverage WTRU.

FIG. 5 is an example process of a MT-LR using sidelink (SL) positioning signaling with security container.

FIGS. 6A and 6B depict an example process of a mobile originated location request (MO-LR) for a target out-of-coverage WTRU.

FIG. 7 depicts an example process of a MT-LR for a target WTRU using an existing connection with a located WTRU.

### DETAILED DESCRIPTION

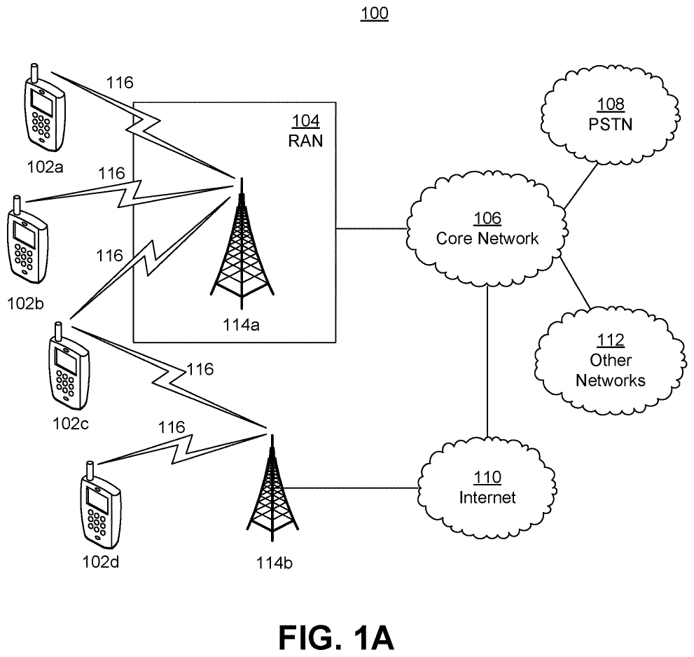

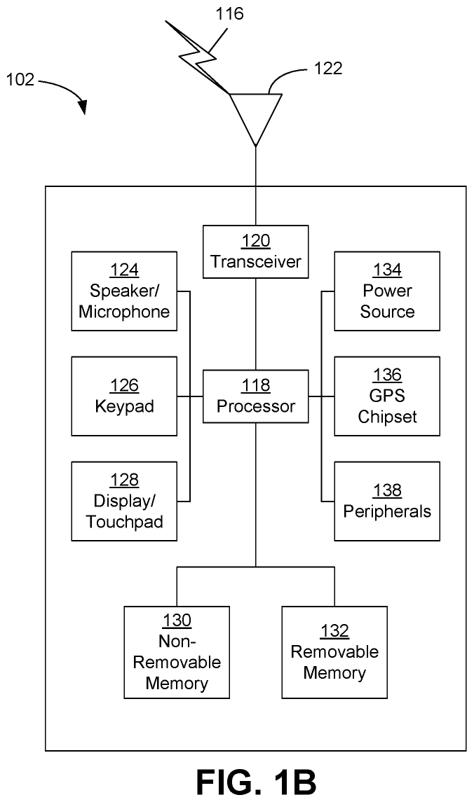

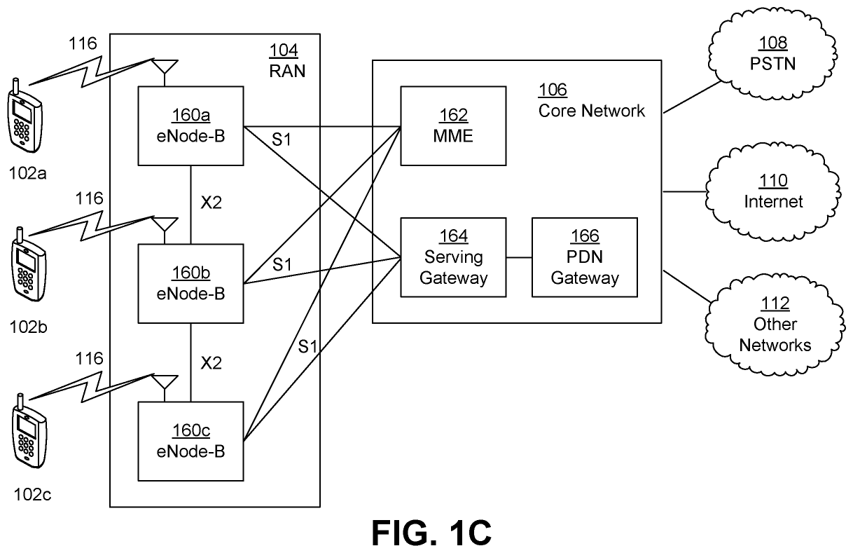

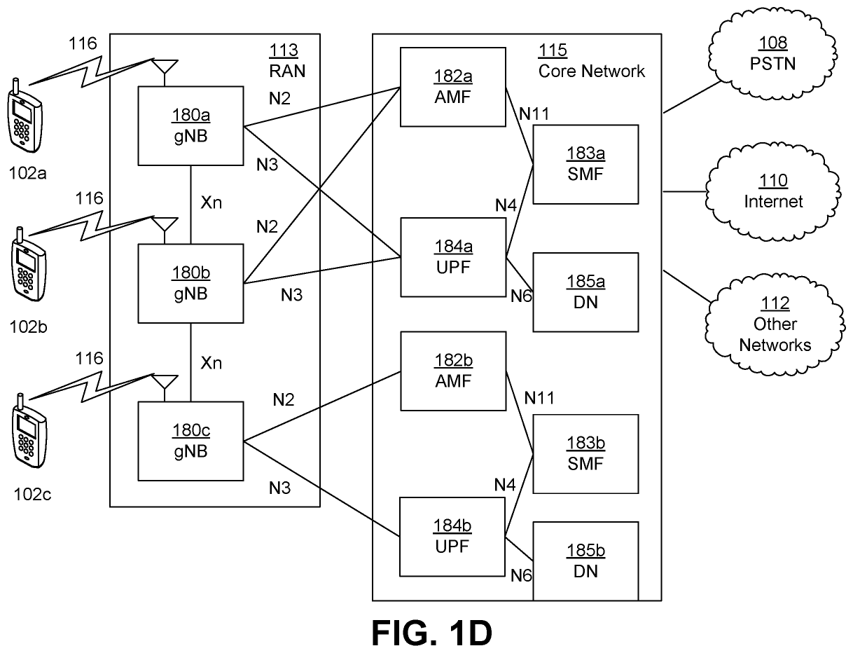

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (loT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VolP) services to one or more of the WTRUS 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANS, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 180b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP (third generation partnership project) access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Described herein are methods and apparatuses for facilitating location-based services for WTRUs that may not be covered by a network (e.g., out-of-coverage). In examples as described herein, sidelink (SL) technology may be utilized to determine a location of a WTRU.

A WTRU (e.g., a target WTRU) may be configured to receive an SL positioning request from another WTRU (e.g., a located WTRU). The first SL positioning request may include security information. The security information may be for validating the SL positioning request. The WTRU (e.g., target WTRU) may be configured to send an SL positioning response to the other WTRU (e.g., located WTRU). The SL positioning response may be sent based on validation of the SL positioning request, for example using at least the security information. The WTRU (e.g., located or target WTRU) may be configured to perform an SL positioning with the other WTRU (e.g., located or target WTRU). Performing an SL positioning with the other WTRU (e.g., located or target WTRU) may include receiving an indication of one or more distance measurements or direction measurements associated with the other WTRU (e.g., located or target WTRU). Additionally, or alternatively, performing an SL positioning with the second WTRU may include determining one or more distance measurements or direction measurements associated with the other (e.g., located or target) WTRU.

The WTRU (e.g., target WTRU) may be configured to receive configuration information. The configuration information may include one or more parameters, for example to derive security credentials for validating the security information in the SL positioning request. The security information may be received in a security container. The security container may be protected by security credentials, for example derived from the one or more parameters received in the configuration information.

The WTRU (e.g., target WTRU) may be configured to verify the validity of the SL positioning request, for example by validating the security information received in the security container. The WTRU (e.g., target WTRU) may be configured to perform discovery with the other WTRU (e.g., located WTRU), for example based on receipt of a (e.g., second) SL positioning request from a network. The security information may include one or more of an application function (AF) ID, location services (LCS) client information, a location information request for the WTRU (e.g., target WTRU), a service type, a list of second WTRUs, quality of service (QOS) information, and/or a type of location request. The SL positioning request may include a list of WTRUs (e.g., located WTRUs), for example in a security container. Validation of the SL positioning request may be based on one or more of the security information and/or the other WTRU (e.g., located WTRU) being in the list of WTRUs (e.g., located WTRUs). The WTRU (e.g., target WTRU) may be configured to initiate a mobile originated location request (MO-LR). The MO-LR may be based on the other WTRU (e.g., located WTRU) being in the list of WTRUs (e.g., located WTRUs).

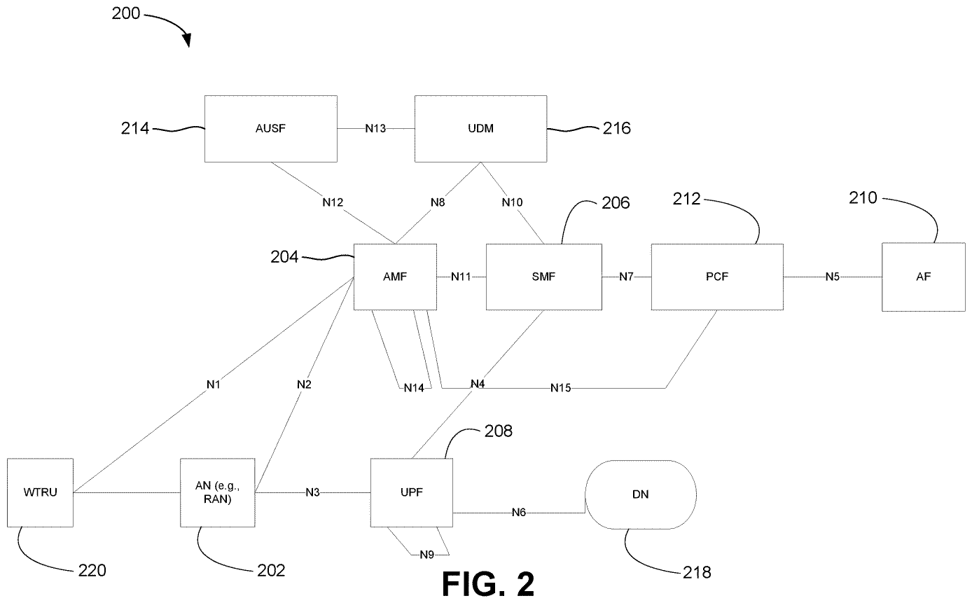

FIG. 2 depicts an example architecture of a fifth generation (5G) or next generation (NextGen) network 200. As depicted in FIG. 2, an access network 202 (e.g., radio access network (RAN)) refers to a 5G radio access technology (RAT) or an evolved universal mobile telecommunications system (UMTS) terrestrial radio access (E-UTRA), that for example may be connected to a NextGen core network.

An access control and mobility management function (AMF) 204 may include one or more of registration management, connection management, reachability management, mobility management, or the like. A session management function (SMF) 206 may include one or more of session management, WTRU IP address allocation, selection and control of user plane (UP) function (UPF) 208, or the like. Session management may include session establishment and/or modify and release. The user plane function (UPF) 208 may include one or more of packet routing and forwarding, packet inspection, traffic usage reporting, or the like.

One or more 5G location services may be configured to send positioning information of a WTRU 220. The positioning of a WTRU 220 may be supported by a RAT-dependent position method. The RAT-dependent position method may rely on one or more of 3GPP RAT measurements obtained by a target WTRU 220 and/or on measurements obtained by an access network of 3GPP RAT signals, for example transmitted by a target WTRU 220. Positioning of a WTRU 220 may be supported by a RAT-independent position method. The RAT-independent position method may rely on non-RAT measurements obtained by a WTRU 220 and/or on other information. Location information for one or more target WTRUs 220 may be requested by and/or reported. For example, location information for one or more target WTRUs 220 may be requested by and/or reported to one or more of a location services (LCS) client, an application function (AF) 210 within or external to a 3GPP operator network, or a control plane network function (NF) within 3GPP system. For location requests from a LCS client and/or an AF 210, privacy verification of the target WTRU 220 may be enabled, for example to check whether it is allowed to acquire location information of the WTRU 220.

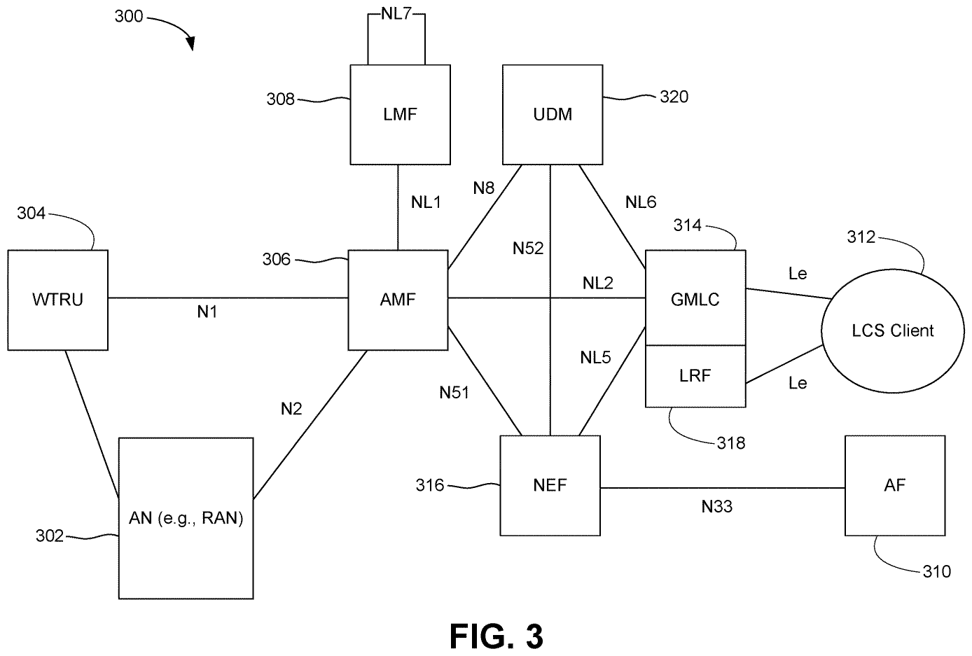

FIG. 3 depicts an example 5G/NextGen network 300 comprising a location service. As depicted in FIG. 3, a AN 302 (e.g., RAN) may represent one or more of a next generation RAN (NG-RAN), a trusted non-3GPP access, or an untrusted non-3GPP access. An access network may be configured to handle one or more positioning procedures. The positioning procedures may include one or more of positioning of a target WTRU 304, sending location related information not associated with a particular target WTRU 304, transfer of positioning messages between an access control and mobility management function (AMF) 306 or location management function (LMF) 308 and a target WTRU 304, or the like. An AF 310 and/or NF may access LCS from a gateway mobile location center (GMLC) 314, for example in the same 3GPP operator network. An LCS client 312 may access LCS from a GMLC 314. An external AF 310 may access LCS from a network exposure function (NEF) 316. A GMLC 314 may be configured to handle one or more of the request from an external LCS client 312, an AF via a NEF 316 if the AF is an external AF, or forward a location request to a proper NF. A location retrieval function (LRF) 318 may be configured to retrieve or validate location information. The LRF 318 may be collocated with an GMLC 314 or separate from the GMLC 314. A LMF 308 may manage (e.g., overall) coordination and/or scheduling of resources (e.g., required) for the location of a WTRU 304 that is registered with or is accessing a 5GCN. The LMF 308 may calculate and/or verify (e.g., final) location related information and/or (e.g., achieved) accuracy. One or more of an LMF 308, LRF 318, and GMLC 314 may be included as network function(s) of a 5CGN.

One or more types of location requests may be supported. For example, a mobile terminated location request (MT-LR) may be supported. With an MT-LR, a LCS client and/or an AF may send a location request to the 5G Network, for example for the location of a target WTRU. A mobile originated location request (MO-LR) may be supported. With an MO-LR, a WTRU may send a request to the 5G network, for example for location related information for the WTRU. An immediate location request may be supported. With an immediate location request, an LCS client and/or an AF may send or initiate a location request for a target WTRU(s) and/or receive a response containing location information for the target WTRU(s) within a short time period. An immediate location request may be used, for example for an MT-LR and/or MO-LR. A deferred location request may be supported. With a deferred location request, a LCS client and/or an AF may send a location request to the 5G network for a target WTRU(s) and/or receive a response, for example when an indicated event occurs for the target WTRU at some future time. A deferred location request may be used for an MT-LR.

Sidelink (SL) positioning may refer to positioning via a PC5 interface. Ranging may refer to the determination of the distance between two or more WTRUs and/or the direction and/or relative positioning of one WTRU from another WTRU. Ranging-based services and/or SL positioning may include one or more of distance measurements, or direction measurements. A WTRU may request a distance measurement and/or a direction measurement. A ranging and/or SL positioning capable WTRU(s) may be proximity services (ProSe) and/or vehicle-to-everything (V2X) capable. A Reference WTRU may refer to a WTRU configured to determine a reference plane and/or reference direction in the ranging based service and/or SL positioning. A target WTRU may refer to a WTRU whose distance, direction and/or position is measured compared to the reference plane, reference direction, and/or location of a reference WTRU (e.g., located WTRU) in the ranging based service and/or SL positioning. A WTRU participating in the ranging and/or sidelink positioning may be both a target WTRU and a reference WTRU, and/or may switch roles in the same ranging and/or SL positioning session. A located WTRU may refer to a WTRU whose location is known or is able to be known, for example using a user to user (Uu)-based positioning 5G system. A located WTRU may be used to determine the location of another WTRU using sidelink positioning. Assistant WTRU may refer to a WTRU that may provide assistance for ranging and/or SL positioning, for example when the direct ranging and/or SL positioning between a reference WTRU and a target WTRU is not supported.

The location information of a WTRU may be supported by a radio access technology (RAT)-dependent method and/or a RAT-independent method. A RAT dependent method may rely on the interaction between a WTRU and a 5G system. A RAT-independent method may rely on information sent from a WTRU.

Described herein are methods and apparatuses for providing WTRU location services, for example when the WTRU is out of coverage. These location services may be applicable to, for example, 5G location services such as MT-LR and/or MO-LR. For user privacy, a WTRU may determine whether a request for location is coming from a legitimate and/or authorized entity. 5G location service(s) may authorize the location request from an AF and/or a LCS client based on checking the WTRU's privacy profile for location services in a unified data management function (UDM). If the WTRU is trusted with the 5G core network (5GCN) and/or if WTRU receives the location request from a 5G system, the WTRU may perform the procedure(s) following the request. When the WTRU is out coverage and the WTRU's location information is requested by an AF and/or a LCS client, the request may be relayed by another WTRU. Even if the WTRU and the other WTRU have no trust relationship, the WTRU may validate the location request coming from the other WTRU. For example, a first WTRU may validate the location request from a second WTRU when the first WTRU is out of coverage. The location service may be used for one or more applications, for example for law enforcement operations and/or emergency services. When a WTRU is out of coverage, the WTRU may ignore location requests, for example regardless of the application of the location request. A WTRU may be aware of the application from which a location request is being requested, and/or the WTRU may respond to the request. For example, the WTRU may respond to the request based on the application from which a location request is being requested.

Methods and apparatuses are described herein with respect to a WTRU supporting a PC5 interface. The PC5 interface may be supported by the ProSe layer in the WTRU(s). Additionally, or alternatively, other appropriate interfaces may be utilized. Methods and apparatuses may include a WTRU being configured for ranging and/or SL positioning.

The network (e.g., 5GCN) may perform one or more of selecting a located WTRU(s) for sidelink positioning with the target WTRU, initiating the located WTRU to discover the target WTRU, and triggering the located WTRU to perform sidelink positioning with the target WTRU. For example, when there is a location request from an AF and/or a LCS client for a target WTRU which is authorized for SL positioning and/or ranging and the 5GCN is aware that the target WTRU is out of coverage, the network (e.g., 5GCN) may perform one or more of selecting a located WTRU(s) for sidelink positioning with the target WTRU, initiating the located WTRU to discover the target WTRU, and/or triggering the located WTRU to perform sidelink positioning with the target WTRU. The network (e.g., 5GCN) may maintain a list of located WTRU(s) within the target WTRU's potential coverage for each target WTRU. For example, the network (e.g., 5GCN) may maintain a list of located WTRU(s) within the target WTRU's potential coverage for each target WTRU according to the last known location of the target WTRU with or without analytic information on mobility of the target WTRU and/or the location of the located WTRU(s).

The network (e.g., 5GCN) may include a security container in the request message, for example in response to a network (e.g., 5GCN) request for the located WTRU to perform sidelink positioning with the target WTRU. The security container may be forwarded to the target WTRU and/or the target WTRU may validate the sidelink positioning request from the located WTRU, for example using information included in the security container. The information in the security container may be protected by one or more security credential. For example, the information in the security container may be protected by one or more security credential shared by the network (e.g., 5GCN) and the target WTRU. A NF configured to handle sidelink positioning may send a request for protection for a sidelink positioning request to an authentication server function (AUSF), for example using a shared key between the AUSF and the target WTRU. Additionally, or alternatively, the NF configured to handle sidelink positioning may send a request for protection for a sidelink positioning request to an authentication server function (AUSF), upon receiving an LCS client or an AF location request. The NF may securely bind the sidelink positioning request to one or more target and/or located WTRU identities. The NF may determine a (e.g., last) serving AUSF, for example by querying a united data management function (UDM). The NF may receive the protected sidelink positioning request from the AUSF. The NF may forward the protected sidelink positioning request to the target WTRU, for example via the located WTRU (e.g., during a discovery procedure or sidelink positioning request). The security container may contain a protected authorization token from the AF which, for example may be forwarded (e.g., transparently) by the network (e.g., 5GCN) to the target WTRU and/or verified by the SL positioning application on the target WTRU.

A target WTRU may announce its capability during registration and/or the target WTRU may be provided with parameters for SL positioning, for example when the target WTRU is configured for SL positioning. Additionally, or alternatively, the target WTRU may send an indication that the target WTRU may perform SL positioning, for example when the WTRU is out of coverage. The target WTRU may be provided with parameters, for example for SL positioning while out of coverage. The parameters may include one or more of target WTRU ID information (e.g., to be used for discovery), PC5 link setup (e.g., for SL positioning applications), ProSe service information (e.g., for the SL positioning application), security credentials, or parameters to derive security credentials. The parameters to derive security credentials may be used to validate and/or decrypt the security container for a location service request from 5GCN. The WTRU may be provided with a list of located WTRU ID information, for example in the registration phase.

The WTRU may be provided with a list of located WTRUs for example, a list of located WTRUs which are installed and/or maintained by an operator or any authority. The list of located WTRUs may be by priority. One or more located WTRUs in the list of located WTRUs may have location information known in the network. Additionally, or alternatively, those located WTRUs may be considered to be trusted and/or authenticated, for example via one or more of separate manners and/or (e.g., relevant) security information. The security information may be shared with the WTRU during registration and/or preconfigured within the WTRU. A WTRU may authenticate the located WTRU (e.g., in one method) with information shared during registration and/or preconfigured (e.g., in a second method), for example when the WTRU receives message from a located WTRU in the list of located WTRUs in priority.

The network (e.g., 5GCN) may include validation information in the location request message and/or parameters (e.g., required) to determine a MO-LR request at the target WTRU (e.g., AF, LCS client type), for example when a network (e.g., 5GCN) initiates a location request with triggering conditions which trigger a MO-LR request from the target (e.g., out of coverage) WTRU, via the located WTRU. The target WTRU may (e.g., internally) check the information to verify the location request is legitimate and/or authorized. And the target WTRU may determine a MO-LR request (e.g., with necessary parameters) using the received information (e.g., the recipient of the location information, quality of service (QOS).

The network (e.g., 5GCN) may include an indication of application of sidelink positioning in the request and/or the indication of application of sidelink positioning may be forwarded to the target WTRU, for example when a network (e.g., 5GCN) requests the located WTRU to perform sidelink positioning with the target WTRU. The target WTRU may utilize the indication of application of sidelink positioning, for example when the target WTRU determines to follow the request received from the located WTRU. For example, when the indication of application of sidelink positioning indicates an emergency service, the target WTRU may determine to not ignore the request, and/or may respond to the request from the located WTRU and/or perform sidelink positioning. The indication of application of sidelink positioning may be included in the security container, for example in order to indicate an origin and/or integrity.

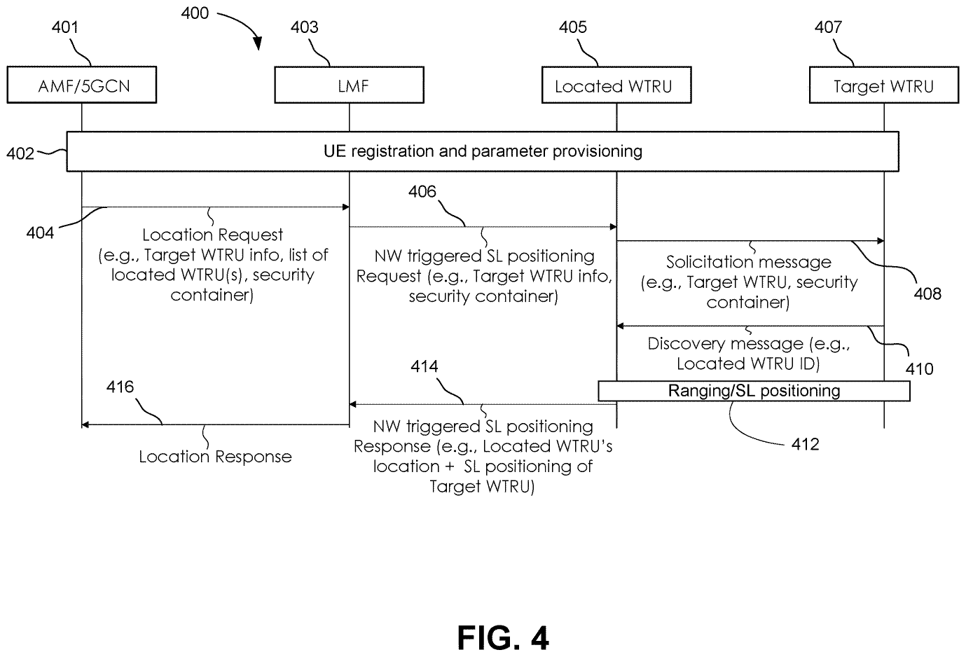

FIG. 4 depicts an example process 400 of a mobile terminated location request (MT-LR) via a located WTRU 405 for a target (e.g., out-of-coverage) WTRU 407. The example addresses how to provide the location information of a WTRU out of coverage (e.g., target WTRU 407) and how to provide security protection on the message to avoid, for example, an attack from a malicious WTRU. Referring to FIG. 4, at 402, if for example a WTRU is capable of SL positioning, the WTRU may inform this capability during registration. Additionally, or alternatively, the WTRU may inform that the WTRU is capable of SL positioning while WTRU is out of coverage and/or the WTRU may be provided with parameters to be used for SL positioning while out of coverage. The parameters one or more of target WTRU ID information (e.g., to be used for discovery), PC5 link setup (e.g., for SL positioning applications), ProSe service information (e.g., for the SL positioning application), security credentials, or parameters to derive security credentials. The parameters to derive security credentials may be used to validate and/or decrypt the security container for a location service request from the network (e.g., 5GCN). The WTRU may be provided with a list of located WTRU ID information, for example in the registration phase. The target WTRU 407 may be provided or preconfigured with a list of located WTRUs in priority.

At 404, the access control and mobility management function (AMF) 401 may be triggered to initiate a location request for a WTRU (e.g., target WTRU 407). The AMF 401 may determine the list of located WTRU(s), for reaching the target WTRU 407 in a PC5 communication, based on the last known location and/or other information (e.g., analytic information of expected location of the target WTRU 407). Additionally, or alternatively, the AMF 401 may determine the list of located WTRU(s), for example when the AMF 401 determines that the target WTRU 407 is not reachable. The AMF 401 may include a security container to protect the information to be forwarded to the target WTRU 407, for example in the location request.

The information in the security container may be protected by encryption and/or integrity protection. Additionally, or alternatively, the security container may be protected with security credentials which may, for example be shared between the network (e.g., 5GCN) and the target WTRU 407 and/or be derived from the information shared between the network (e.g., 5GCN) and the target WTRU 407.

The information in the security container may include information for validating the location request. The information (e.g., for validating the location request) may include one or more an AF ID and/or LCS client information requested location information of the target WTRU 407, service and/or application type of SL positioning, a requested positioning method, a list of candidate located WTRUs, QoS information for the location request, type of location request (e.g. immediate location request, deferred location request with trigger condition), or signature and/or information for integrity checking and relating security parameters to be used to decryption and/or validation of security container. The signature or information for integrity check and security parameters may be different, for example based on the security mechanism (e.g., when different security mechanisms are used). Additionally, or alternatively, the AMF 401 may determine the list of located WTRUs in priority and/or inform the location management function (LMF) 403. Alternatively, or additionally, the LMF 403 may maintain the list of located WTRUs and/or list of located WTRUs in priority. The LMF 403 may select a list of located WTRU(s) to use for acquiring the location of the target WTRU 407, for example when the LMF 403 receives the location request for the target WTRU 407 (e.g., which is out of coverage).

At 406, the LMF 403 may send a positioning request to the located WTRU 405. For example, the LMF 403 may send a network (NW) triggered positioning request to the located WTRU 405 when the LMF 403 receives the location request from the AMF 401. The network (NW) triggered SL positioning request may be sent via the RAN, for example to the located WTRU(s) in the list of located WTRUs. The list of located WTRUs may be received from the AMF 401 and/or maintained by the LMF 403. The LMF 403 may include the security container information in the SL positioning request, for example sent to located WTRU(s).

At 408, the located WTRU 405, which for example has received the NW triggered SL positioning request from LMF 403 via the RAN, may trigger PC5 discovery procedure(s) to discover the target WTRU 407. The located WTRU 405 may include a target WTRU's ID information and/or security container in a solicitation message, for example when the located WTRU 405 sends a solicitation message. The target WTRU's ID information may be provided at the target WTRU 407 during registration phase and/or may be provided to the located WTRU 405, for example by the LMF 403 in the SL positioning request. At 408, if the located WTRU 405 received the NW triggered SL positioning request and the target WTRU 407 already has a PC5 unicast link established which may be determined with the target WTRU ID information, the located WTRU 405 may skip the discovery phase at 408 and/or at 410, and/or perform SL positioning at 412 in which the located WTRU 405 may include a security container in the SL positioning request to the target WTRU 407. At 412, the located WTRU 405 may include a security container in the SL positioning request to the target WTRU 407, for example to perform SL positioning.

At 410, for example when the target WTRU 407 receives a solicitation message indicating target WTRU 407, the target WTRU may decode the solicitation message and the information in the security container. After validating the message with information in the security container, the target WTRU 407 may respond with a response message. The response message may include the located WTRU ID (e.g., which is the sender of the solicitation message). When the solicitation message is not validated by the target WTRU 407, the target WTRU 407 may reject the solicitation message and/or ignore the solicitation message. Alternatively, or additionally, when the target WTRU 407 receives a solicitation message from a WTRU (e.g., the located WTRU 405) in the list of located WTRUs in priority, the target WTRU 407 may authenticate the authentication message separately.

At 408 or at 410, the target WTRU 407 may receive multiple discovery messages and/or SL positioning requests from multiple located WTRUs. The security container included in those messages may indicate the same information in the security containers. For example, the target WTRU 407 may respond to only one located WTRU per target WTRU selection, which may avoid duplication and/or replay attacks.

At 412, the located WTRU 405 may perform SL positioning with the target WTRU 407, for example using a PC5 signaling message. The located WTRU 405 may perform SL positioning with the target WTRU 407 after receiving the response message from the target WTRU 407 including, for example the located WTRU information. Alternatively, or additionally, the target WTRU 407 and the located WTRU 405 may establish a PC5 unicast connection. The located WTRU 405 may perform SL positioning with the target WTRU 407 over the PC5 connection. The target WTRU 407 may verify the security container and/or accept the SL positioning request after successful verification, for example after receiving a SL positioning request with security container from the located WTRU 405.

At 414, the located WTRU 405 may respond to the LMF 403, for example after successfully finishing SL positioning procedure. The located WTRU 405 may respond to the LMF 403 via the RAN, for example using the NW triggered SL positioning response. The NW triggered SL response may include the result of the SL positioning with the target WTRU 407. The located WTRU 405 may additionally, or alternatively, include the positioning information of the located WTRU 405 in the NW triggered SL positioning response.

At 416, the LMF 403 may determine the location information of the target WTRU 407, for example by using the SL positioning information of the target WTRU 407 and/or location information of the located WTRU 405. The LMF 403 may determine the location information of the target WTRU 407 after receiving the NW triggered SL positioning response from the located WTRU 405. The LMF 403 may respond to the AMF 401 with location information of the target WTRU 407 which, for example may be determined by LMF 403.

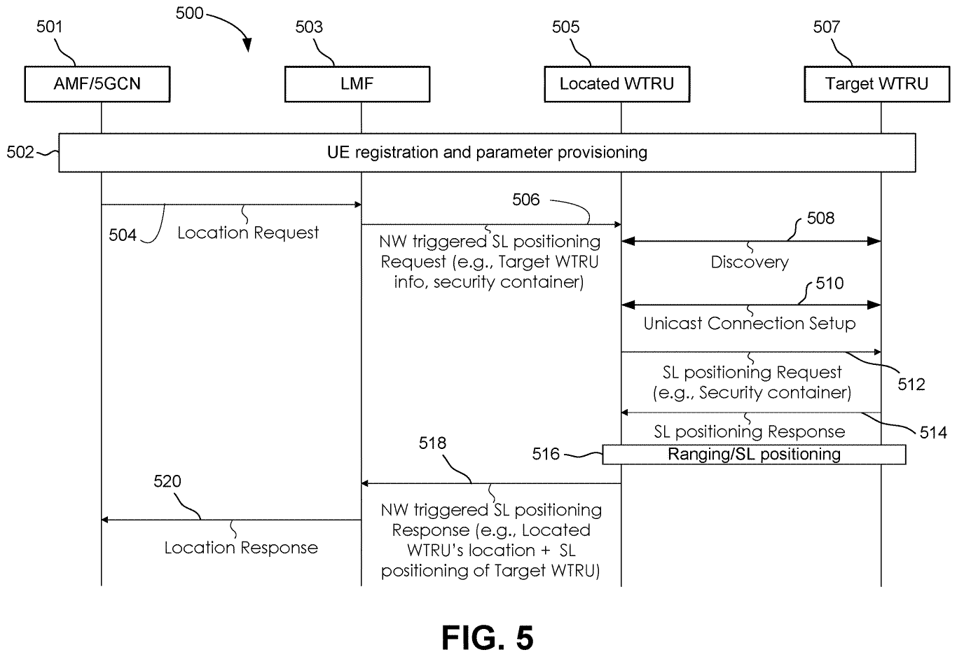

FIG. 5 is an example process 500 of a mobile termination location request (MT-LR) using sidelink (SL) positioning signaling with a security container. As depicted in FIG. 5, a procedure for performing an MT-LR may utilize SL positioning signaling with a security container. The located WTRU 505 may exchange information in the security container. The security container may be received from the LMF 503. The located WTRU 505 may receive the validation response, for example during the SL positioning signaling procedure after the discovery procedure. At 502, if a WTRU is capable of SL positioning for example, the WTRU may announce its capability during registration. Additionally, or alternatively, the WTRU may announce its capability of SL positioning while the WTRU is out of coverage and/or the WTRU may be provided with parameters to be used for SL positioning (e.g., while out of coverage). The parameters may include one or more of target WTRU ID information (e.g., to be used for discovery and/or PC5 link setup for SL positioning application), ProSe service information (e.g., for the SL positioning application), security credentials, and/or parameters to derive security credentials. The security credentials and/or parameters to derive security credentials may be used to validate and/or decrypt the security container, for example for a location service request from 5GCN. The target WTRU 507 may be provided with a list of located WTRU ID information.

At 504, the AMF 501 may be triggered to initiate a location request for a WTRU (e.g., target WTRU 507). In the location request, the AMF 501 may include a security container to protect the information to be forwarded to the target WTRU 507. At 506, the LMF 503 may send a NW triggered SL positioning request, for example via the RAN to the selected located WTRUs. The SL positioning request may include the security container information.

At 508 and 510, the located WTRU 505 may perform a PC5 based discovery procedure to discover the target WTRU 507 and a PC5 unicast connection setup procedure with the target WTRU 507 after successful discovery procedure with the target WTRU 507. The located WTRU 505 may send a solicitation message to the target WTRU 507. The solicitation message may include the target WTRU information. The located WTRU 505 may receive a response message from the target WTRU 507. The located WTRU 505 may trigger a PC5 unicast connection setup procedure with the target WTRU 507. The located WTRU 505 may send an announcement message, for example to the target WTRU 507. The announcement message may include the located WTRU information and/or the target WTRU information. The target WTRU 507 may trigger a PC5 unicast connection setup procedure with the located WTRU 505. The announcement message (e.g., solicitation message) from the located WTRU 505, may include security information (e.g., encrypted hash value of target WTRU ID or protected indicator that shows the request is from network). Using this security information, the target WTRU 507 may check to determine if the discovery request from the located WTRU 505 is per the network's request and/or authorization.

At 512, the located WTRU 505 may send an SL positioning request, for example after successful setup of the PC5 unicast connection setup with the target WTRU 507. The SL positioning request may include security container information. The security container information may be received from the LMF 503, for example via the RAN. Alternatively, or additionally, the target WTRU 507 may authenticate the located WTRU 505 in a separate manner, for example when the target WTRU 507 discovers and sets up the PC5 unicast connection with a located WTRU 505 in the list of located WTRUs in priority.

At 514, the target WTRU 507 may accept the request with an SL positioning response, for example after validating the message with information in the security container. At 516, the located WTRU 505 may perform SL positioning with the target WTRU 507, for example after receiving the SL positioning response. At 518, the located WTRU 505 may respond to the LMF 503, for example via the RAN using the NW triggered SL positioning response. The SL positioning response may include the result of SL positioning with the target WTRU 507. The located WTRU 505 may respond to the LMF 503 after successfully finishing the SL positioning procedure. At 520, the LMF 503 may determine the location information of the target WTRU 507, for example by using the SL positioning information of the target WTRU 507 and/or location information of the located WTRU 505. The LMF 503 may determine the location information of the target WTRU 507, for example after receiving the NW triggered SL positioning response from the located WTRU 505. The LMF 503 may respond to the AMF 501 with location information of the target WTRU 507.

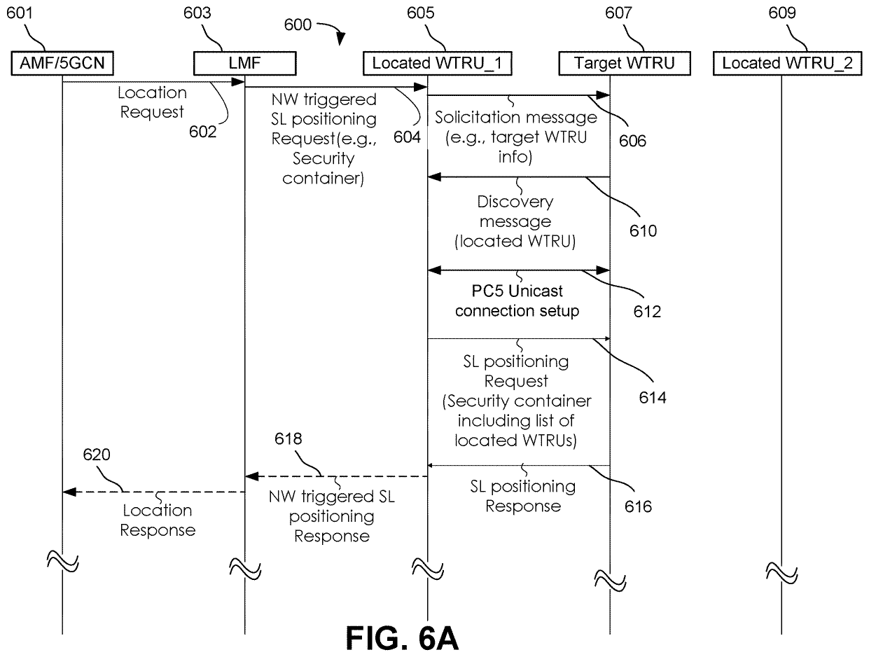

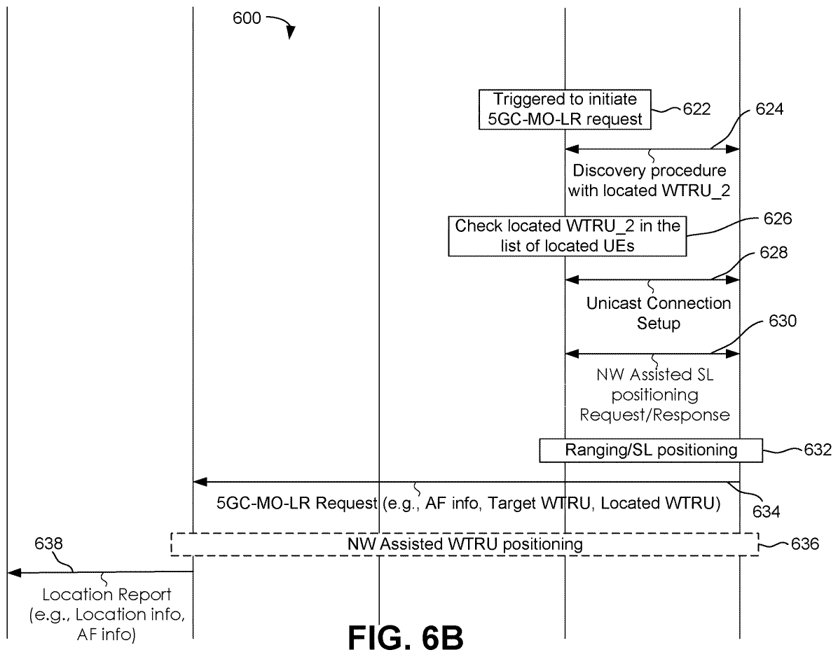

FIGS. 6A and 6B depict an example process 600 of a mobile originated location request (MO-LR) for a target out-of-coverage WTRU. FIGS. 6A and 6B illustrate location information of a WTRU out of coverage being provided with a 5G MO-LR type location request. The MO-LR type location request may be requested by the target WTRU, for example when one or more conditions, to trigger the request, are satisfied. The required information to compose a MO-LR type location request may be provided prior to the MO-LR type location request, for example by the 5GCN. For example, the location request from the AMF may be for a deferred location request. The target WTRU may initiate a 5G MO-LR, for example when a triggering condition(s) is satisfied. When the target WTRU is out of coverage for example (e.g., in order to send a 5G MO-LR type location request), there may be a method to enable that the target WTRU to select a located WTRU which is authorized by 5GCN to function as a located WTRU.

Referring to FIG. 6A, at 602, if a WTRU is capable of SL positioning, the WTRU may announce this capability during registration. Additionally, or alternatively, the WTRU may announce that it is capable of SL positioning while the WTRU is out of coverage and/or the WTRU may be provided with parameters to be used for SL positioning while out of coverage. The parameters may include one or more of a target WTRU ID information (e.g., to be used for discovery and/or PC5 link setup for SL positioning application), ProSe service information (e.g., for the SL positioning application), security credentials, and/or parameters to derive security credentials. The security credentials and/or parameters to derive security credentials may be used to validate and/or decrypt the security container, for example for a location service request from 5GCN. The target WTRU 607 may receive a list of located WTRU ID information from 5GC, for example. The list may include one or more located WTRUs 605, 609. Additionally, or alternatively, the target WTRU 607 may be sent or preconfigured with a list of located WTRUs in priority, for example from 5GC.

At 604, the AMF 601 may be triggered to initiate a location request for a WTRU (e.g., target WTRU 607). In the location request, the AMF 601 may include a security container, for example to protect the information to be forwarded to the target WTRU 607. At 606, the LMF 603 may send a NW triggered SL positioning request, for example via the RAN to the selected located WTRUs. The LMF 603 may send the NW triggered SL positioning request after receiving the location request. The NW triggered SL positioning request may include the security container information.

At 610 and 612, the located WTRU_1 605, which received the NW triggered SL positioning request, may perform a PC5 based discovery procedure and/or a PC5 unicast connection setup procedure with the target WTRU 607, for example after successful discovery procedure with the target WTRU 607. The PC5 based discovery procedure may be for discovering the target WTRU 607. For example, the located WTRU_1 605 may send a solicitation message, for example including target WTRU information, and/or may receive a response message from the target WTRU 607. The located WTRU 605, 609 may initiate a PC5 unicast connection setup procedure with the target WTRU 607. As another example, the located WTRU 605, 609 may send an announcement message. The announcement message may include the located WTRU information and/or the target WTRU information. The target WTRU 607 may initiate a PC5 unicast connection setup procedure with the located WTRU 605, 609, for example after receiving the announcement message.

At 614, the located WTRU_1 605 may send a SL positioning request, for example after successful setup of the PC5 unicast connection with the target WTRU 607. The SL positioning request may include security container information which, for example, may be received from the LMF 603 via the RAN. Alternatively, or additionally, the target WTRU 607 may authenticate the located WTRU 605, 609 in a separate manner, for example when the target WTRU 607 discovers and/or sets up the PC5 unicast connection with a located WTRU 605, 609 in the list of located WTRUs in priority.

At 616, the target WTRU 607 may respond with an SL positioning response, for example after validating the message with information in the security container. The security container may include a list of located WTRUs. The list of located WTRUs may indicate the legitimate and/or authorized located WTRUs. The target WTRU 607 may store one or more trigger conditions. For example, when the SL positioning request indicates that the requested location request type is a deferred location request, the target WTRU 607 may store one or more of the trigger conditions. The target WTRU 607 may initiate a 5GC-MO-LR type location request. For example, when one or more of the trigger conditions are satisfied, the target WTRU 607 may initiate a 5GC-MO-LR type location request.

At 618, the located WTRU_1 605 may respond to the LMF 603 with the NW triggered SL positioning response, for example to indicate that the request was delivered successfully. The located WTRU_1 605 may respond to the LMF 603 with the NW triggered SL positioning response after receiving the SL positioning response. At 620, the LMF 603 may respond to the AMF 601 with a location response, for example to indicate the location request was successfully delivered. For example, the LMF 603 may respond to the AMF 601 with a location response after receiving the SL positioning response.

Referring to FIG. 6B, the example process 600 of a mobile originated location request (MO-LR) for a target out-of-coverage WTRU continues. At 622, the target WTRU 607 may initiate a procedure for a 5GC-MO-LR request, for example when one or more trigger conditions are satisfied. At step 624 and 626, the target WTRU 607 may perform a discovery procedure, for example to find available located WTRUs 605, 609. When the target WTRU 607 discovers a located WTRU 609 (e.g., WTRU_2 in FIG. 6), the target WTRU 607 may check whether the located WTRU_2 609 is in the list of located WTRUs which, for example is received at 612.

At 628, the target WTRU 607 may initiate a PC5 unicast connection setup, for example after successful validation of the located WTRU_2 609 in the list of located WTRUs. At 630, the target WTRU 607 may send a NW Assisted SL positioning request to the located WTRU_2 609. The NW Assisted SL positioning request may include information to compose a 5GC-MO-LR request message at the located WTRU_2 609 (e.g., one or more of information about the consumer of the location information of target WTRU 607, AF ID and/or LCS client ID, QoS information for the location request, requested positioning method, or the like).

At 632, the target WTRU 607 and the located WTRU_2 609 may perform SL positioning. At 634, the located WTRU_2 609 may send a 5GC-MO-LR request to the LMF 603. The 5GC-MO-LR request message may include one or more of a target WTRU ID, a located WTRU ID, a consumer AF, a LCS client ID, a result of SL positioning between located WTRU_2 609 and the target WTRU 607, or the like. The 5GC-MO-LR request message may include one or more of QoS information for location, positioning information of located WTRU(s) 605, 609, requested positioning method, or the like.

At 636, the LMF 603 may perform a procedure to determine location information of the located WTRU_2 609, for example after receiving the 5GC-MO-LR request. At 638, the LMF 603 may send a location report to the AMF 601, for example after determining the location information of the target WTRU 607. The location report may include one or more of the location information of the target WTRU 607, consumer AF and/or LCS client ID, QOS information of the location information, or the like.

A 5G MO-LR may be requested by an application. For example, a WTRU's location information may be acquired by an application and/or the request from the application may not be ignored. For example, in a disaster case, to rescue persons in danger, it may be important to identify the location of a WTRU. The location request may be responded to by the WRTU. In order to indicate the seriousness of the location request for example, the location request information may include an indication of application of sidelink positioning. The WRTU may determine that the location request cannot be ignored, for example when the WRTU receives the location request with the indication of the application of sidelink positioning. If the indication indicates the emergency service for example, the location request may be responded to by the WRTU.

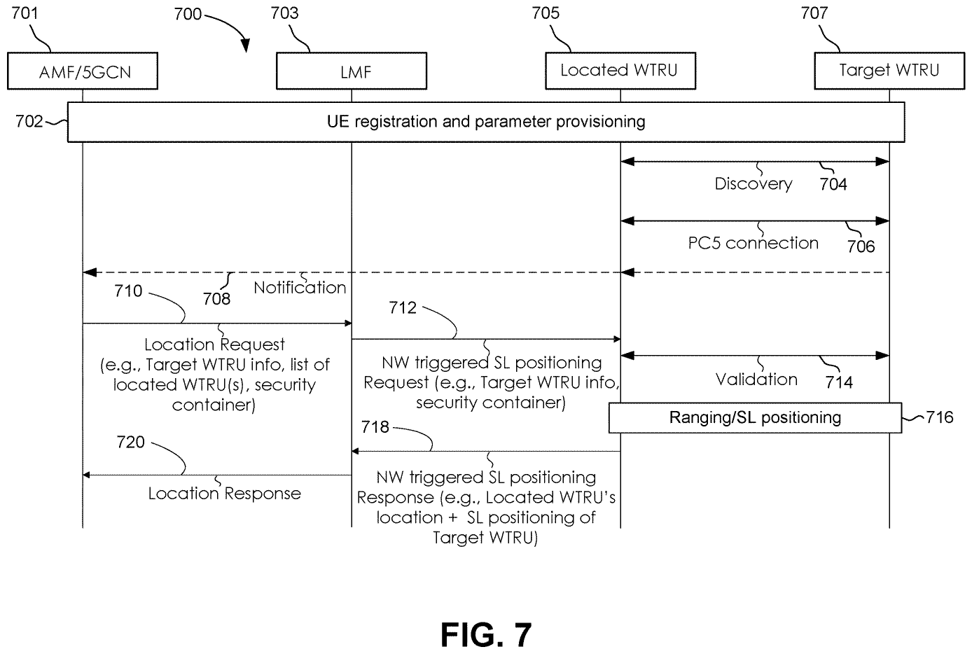

FIG. 7 depicts an example process 700 of a MT-LR for a target WTRU 707 using an existing connection with a located WTRU 705. FIG. 7 illustrates location information of an out-of-coverage WTRU (e.g., target WTRU 707) via a located WTRU 705 being provided when the located WTRU 705 and target WTRU 707 maintain a PC5 connection.

At 702, if a WTRU is capable of SL positioning for example, the WTRU may announce its capability during registration. Additionally, or alternatively, the WTRU may announce its ability to perform SL positioning while the WTRU is out of coverage and/or the WTRU may be provided with parameters, for example to be used for SL positioning while out of coverage. The parameters may include one or more of a target WTRU ID information (e.g., to be used for discovery and/or PC5 link setup for SL positioning application), ProSe service information (e.g., for the SL positioning application), security credentials, and/or parameters to derive security credentials. The security credentials and/or parameters to derive security credentials may be used to validate and/or decrypt the security container, for example for a location service request from the network (e.g., 5GCN). The target WTRU 707 may be provided with a list of located WTRU ID information.

At 704 and 706, target WTRU 707 may initiate discovery with a WTRU (e.g., located WTRU 705) in the list of located WTRUs, for example using ID information. Additionally, or alternatively, the target WTRU 707 may initiate a PC5 connection setup with a located WTRU 705. The target WTRU 707 may authenticate the located WTRU 705 in a separate manner, for example when the target WTRU 707 discovers and sets up a PC5 unicast connection with the located WTRU 705 in the list of located WTRUs in priority. At 708, target WTRU 707 may send a notification that the target WTRU 707 is connecting to a located WTRU 705. The notification may include the located WTRU information. Alternatively, or additionally, the located WTRU 705 may send a notification to the target WTRU 707 that the located WTRU 705 is connected with the network (e.g., 5GCN). For security reasons, the located WTRU 705 and/or the target WTRU 707 may include the signature of the target WTRU 705, for example, to indicate that the notification is coming from a genuine WTRU, for example in the notification. The notification may be sent to the LMF 703 and/or the LMF 703 may maintain the list of located WTRUs and/or a status of the target WTRU's 707 connection with the located WTRUs.

At 710, the AMF 701 may be triggered to initiate a location request for target WTRU 707. The AMF 701 may send, at 710, the location request to the LMF 703, for example when the AMF 701 is aware that the target WTRU 707 is not reachable. The location request may include one or more of target WTRU 707 information, a list of located WTRU(s), and/or a security container. The security container may include protected location request information to the target WTRU 707. Additionally, or alternatively, the AMF 701 may compose the list of located WTRUs in priority (e.g., an ordered list of located WTRUS in priority order) and/or send the list of located WTRUs in priority to the LMF 703. The AMF may include the located WTRU 705 in the list of located WTRUs, for example when the located WTRU 705 is connected with the target WTRU 707. The AMF 701 may compose a list of located WTRUS (e.g., only) with the located WTRU 705 which notified that the target WTRU 707 is in connection. Additionally, or alternatively, the AMF 701 may include one or more located WTRUs which are known to be in proximity with the located WTRU 705 and the located WTRUs which, for example notified that the target WTRU 707 is in connection. The information in the security container may be protected by one or more of encryption protection, integrity protection, and/or security credentials. The security credentials may be shared between the network (e.g., 5GCN) and the target WTRU 707 and/or may be derived by the information shared between the network (e.g., 5GCN) and the target WTRU 707. The information in the security container may include information for validating the location request (e.g., one or more of AF ID and/or LCS client information, requested location information of target WTRU_1, a service and/or application type of SL positioning, a requested positioning method, a list of candidate located WTRUs, QoS information for the location request, a type of location request, or the like). The type of location request may include one or more of an immediate location request or a deferred location request with a trigger condition. The LMF 703 may maintain the list of located WTRUs. The LMF 703 may select a list of located WTRU(s) to use for acquiring the location of the target WTRU 707, for example when the LMF 703 receives the location request for the target WTRU 707 which is out of coverage. The LMF 703 may include the located WTRU 705 which notified that the target WTRU 707 is connected with, for example when the LMF 703 composes the list of located WTRUs.

At 712, the LMF 703 may send the NW triggered SL positioning request (e.g., via the RAN) to the located WTRUs in the list of located WTRUs, for example when the LMF 703 receives the location request from the AMF 701 that indicates the target WTRU 707. The list of located WTRUs may be received from the AMF 701 and/or maintained by LMF 703. The LMF 703 may include the security container information in the SL positioning request sent to located WTRUs.

At 714, one or more located WTRUs (e.g., the located WTRU 705) may discover target WTRU 707, for example when the located WTRUs receive the NW triggered SL positioning request. The located WTRU 705 may establish a PC5 connection when target WTRU 707 is discovered. The located WTRU 705 may forward a security container and/or information associated with the security container to target WTRU 707 over the maintained PC5 connection, for example when the located WTRU 705 which maintains a PC5 connection with the target WTRU 707 receives the NW triggered SL positioning request. The target WTRU 707 (e.g., then) may validate the security container and the security container contents. Alternatively, or additionally, the target WTRU 707 may skip authentication of the located WTRU 705 or authenticate the located WTRU 705 in a separate manner, for example when the target WTRU 707 is in connection with the located WTRU 705 in the list of located WTRUs in priority. At 716, for example after successful validation of the security container by target WTRU 707, the located WTRU 705 and target WTRU 707 may perform a SL positioning procedure over the maintained PC5 connection. Alternatively, or additionally, the located WTRU 705 may perform SL positioning with target WTRU 707 independently. For example, even if a SL positioning request is not received the located WTRU 705 may send the SL positioning information with target WTRU 707 information and/or other information (e.g., location information of the located WTRU 705 when a NW triggered SL positioning request is received at 712). The located WTRU 705 may skip 714, for example if the located WTRU 705 is configured and/or there is an indication that validation is not required by the network (e.g., 5GCN).

At 718, the located WTRU 705 may respond to the LMF 703 via the RAN using NW triggered SL positioning response, for example after successfully finishing the SL positioning procedure. The NW triggered SL positioning response may include the result of the SL positioning with target WTRU 707. The located WTRU 705 may include positioning information of the located WTRU 705 in the NW triggered SL positioning response. At 720, the LMF 703 may determine the location information of target WTRU 707, for example after receiving the NW triggered SL positioning response from the located WTRU 705. The LMF 703 may determine the location information of target WTRU 707 by using SL positioning information of target WTRU 707 and/or location information of the located WTRU 705. The LMF 703 may respond to the AMF 701, for example with location information of target WTRU 707.

What is claimed is:

1-20. (canceled)

21. A method implemented by a first wireless transmit/receive unit (WTRU), the method comprising:
receiving a first sidelink (SL) positioning request from a second WTRU, wherein the first SL positioning request comprises security information for validating the first SL positioning request and configuration information that includes one or more parameters to derive security credentials for validating the security information in the first SL positioning request;
sending a first SL positioning response to the second WTRU, wherein the first SL positioning response is sent based on validation of the first SL positioning request using at least the security information; and
performing an SL positioning with the second WTRU.

22. The method of claim 21, wherein performing an SL positioning with the second WTRU comprises receiving an indication of one or more distance measurements or direction measurements associated with the second WTRU.

23. The method of claim 21, wherein performing an SL positioning with the second WTRU comprises determining one or more distance measurements or direction measurements associated with the second WTRU.

24. The method of claim 21, wherein the security information is received in a first security container that is protected by the security credentials derived from the one or more parameters received in the configuration information.

25. The method of claim 24, comprising verifying the validity of the first SL positioning request by validating the security information received in the first security container.

26. method of claim 21, comprising performing discovery with the second WTRU based on receipt of a second SL positioning request from a network.

27. The method of claim 21, wherein the security information comprises one or more of an application function (AF) ID, location services (LCS) client information, a location information request for the first WTRU, a service type, a list of second WTRUs, quality of service (QOS) information, or a type of location request.

28. The method of claim 21, wherein the first SL positioning request comprises a list of second WTRUs in a second security container.

29. The method of claim 28, wherein validation of the first sidelink positioning request is based on one or more of the security information or the second WTRU being in the list of second WTRUs.

30. The method of claim 21, comprising initiating a mobile originated location request (MO-LR) based on the satisfaction of one or more trigger conditions.

31. A first wireless transmit/receive unit (WTRU) comprising:
a processor configured to:
receive a first sidelink (SL) positioning request from a second WTRU, wherein the first SL positioning request comprises security information for validating the first SL positioning request and configuration information that includes one or more parameters to derive security credentials for validating the security information in the first SL positioning request;
send a first SL positioning response to the second WTRU, wherein the first SL positioning response is sent based on validation of the first SL positioning request using at least the security information; and
perform an SL positioning with the second WTRU.

32. The first WTRU of claim 31, wherein performing an SL positioning with the second WTRU comprises receiving an indication of one or more distance measurements or direction measurements associated with the second WTRU.

33. The first WTRU of claim 31, wherein performing an SL positioning with the second WTRU comprises determining one or more distance measurements or direction measurements associated with the second WTRU.

34. The first WTRU of claim 31, wherein the security information is received in a first security container that is protected by the security credentials derived from the one or more parameters received in the configuration information.

35. The first WTRU of claim 34, wherein the processor is configured to verify the validity of the first SL positioning request by validating the security information received in the first security container.

36. The first WTRU of claim 31, wherein the processor is configured to perform discovery with the second WTRU based on receipt of a second SL positioning request from a network.

37. The first WTRU of claim 31, wherein the security information comprises one or more of an application function (AF) ID, location services (LCS) client information, a location information request for the first WTRU, a service type, a list of second WTRUs, quality of service (QOS) information, or a type of location request.

38. The first WTRU of claim 31, wherein the first SL positioning request comprises a list of second WTRUs in a second security container.

39. The first WTRU of claim 38, wherein validation of the first sidelink positioning request is based on one or more of the security information or the second WTRU being in the list of second WTRUs.

40. The first WTRU of claim 31, wherein the processor is configured to initiate a mobile originated location request (MO-LR) based on the satisfaction of one or more trigger conditions.
